(19) United States
(12) Patent Application Publication
(10) Pub. No.: US 2012/0244772 A1
(43) Pub. Date: Sep. 27, 2012

(54) MULTILAYER FABRIC PLATFORM DESIGNED FOR FLAME AND THERMAL PROTECTION

(75) Inventor: Jason Douglas ELDER, Charlotte, NC (US)

(73) Assignee: BARRDAY INC., Cambridge (CA)

(21) Appl. No.: 13/426,419

(22) Filed: Mar. 21, 2012

Related U.S. Application Data
(60) Provisional application No. 61/466,263, filed on Mar. 22, 2011.

(51) Int. Cl. B32B 5/26; D03D 11/00; D03D 13/00; D03D 23/00

(52) U.S. Cl. 442/203; 139/11; 139/409; 442/239

(57) ABSTRACT

According to one aspect, a multi-layer thermal protective fabric including a first layer having at least some yarns having flame resistant properties, a second layer adjacent the first layer, and a least one cross link yarn securing the first layer to the second layer.

### RELATED APPLICATIONS

This application claims the benefit of U.S. Provisional Patent Application Ser. No. 61/466,263 file Mar. 22, 2011 and entitled “Multilayer Fabric Platform Designed for Flame and Thermal Protection”, the entire contents of which are hereby incorporated by reference herein for all purposes.

### TECHNICAL FIELD

The embodiments disclosed herein relate to woven fabrics and in particular to multi-layer woven fabrics adapted to provide thermal protection and having at least some flame resistant or thermally protective yarns and at least some cross-link yarns adapted to secure two or more fabric layers together.

### INTRODUCTION

Various occupations often involve exposure to hazardous environments where there is a risk of burns occurring, such as due to the presence of open flames or elevated temperatures. For example, some military personnel, firefighters and other emergency first responders, industrial workers such as welders and steelworkers, electrical workers and the like, may be exposed to open flames, elevated temperatures or other conditions where burn injuries due to fire or heat exposure are a concern.

Persons working in such hazardous environments are normally provided with flame or thermal resistant clothing (e.g. garments with good insulative properties, self-extinguishing properties, etc.) to avoid or at least reduce the chance of injury due to burns. Some types of thermal protective clothing could include pants, gloves, shirts, jackets, coveralls, hoods, boots, and generally any other desired types of clothing (e.g. firefighter “turn-out gear” or “proximity gear”).

In other cases, it may be desirable to provide thermal protection for equipment (particularly heat-sensitive equipment) or materials, or for use in thermal containment or control applications.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is an image of a fabric designed for thermal protection according to one embodiment;

FIG. 2 is another image of the fabric of FIG. 1;

FIG. 3 is an image of a fabric designed for thermal protection according to another embodiment;

FIG. 4 is an image of a conventional multi-layer fabric without cross links;

FIG. 5 is another image of the fabric of FIG. 4;

FIG. 6 is a schematic of a pattern for a twill/plain weave multi-layer fabric designed for thermal protection according to one embodiment;

FIG. 7 is a drawing plan schematic for the fabric of FIG. 6;

FIG. 8 is a schematic of a pattern of a twill/plain weave multi-layer fabric designed for thermal protection according to another embodiment;

FIG. 9 is a drawing plan schematic for the fabric of FIG. 8;

FIG. 10 is an image of a twill/plain weave multi-layer fabric according to another embodiment;

FIG. 11 is an image of a blended twill/plain weave multi-layer fabric according to another embodiment;

FIG. 12 is a schematic of a pattern of a twill/twill weave multi-layer fabric according to one embodiment;

FIG. 13 is a schematic of a pattern of a blended twill/twill weave multi-layer fabric according to another embodiment;

FIG. 14 is an image of a twill/plain multi-layer fabric according to another embodiment; and

FIG. 15 is an imaged of a twill/plain multi-layer fabric according to yet another embodiment.

### DETAILED DESCRIPTION

Various embodiments herein are directed to multi-layer fabric designs that provide a platform for using a variety of alternative yarns to suit one or more particular applications and cost structures, particularly for use in providing thermal protection in clothing and other garments (e.g. pants, shirts, jackets, coveralls, and so on).

In particular, one or more multi-layer fabric designs as described herein may provide better thermal transmission efficiency or flame resistance (or both) as compared to a conventional single layer fabric design of equal or comparable weight.

In some embodiments, a fabric pattern is selected that allows for various combinations of additional yarn insertions (e.g. of yarns with different structural and/or thermal properties) over and above a particular weave pattern (e.g. a basic weave pattern) to provide for additional mechanical properties or thermal properties (or both). For example, in some embodiments one or more aramid cross-link yarns may be inserted into a fabric at a particular frequency or pattern within a woven fabric as structural fibers that provide tear resistance, shear resistance between the fabric layers, and abrasion resistance, or some combination thereof.

Generally, within various different fabric patterns for each layer, two types of cross-link fibers may be provided so as to join the two (or more) layers of fabric together and form a multi-layer fabric. For example, in some embodiments, a 3-1 Rev Twill/Plain Weave multi-layer fabric may be secured together using at least some of the thermal protective fibres (which may be smaller in size) as cross link fibers that are adapted to secure the layers together without generally increasing the strength or other mechanical properties of the fabric. The fabric may also include structural cross-link fibres (e.g. made of an aramid or other material and which may be larger) that are selected to improve the mechanical properties of the fabric.

In some embodiments, at least some of the cross-links fibres may be blended. In particular, blending cross-link fibers using more efficient or patterned derived crosslinks tends to enable the patterns within both planes of a multilayer fabric weave to be blended together (unlike a traditional multilayer) thus creating a more uniform surface continuity. In contrast, a standard multi-layer fabric may have gaps where either the cross-links are exposed or the alternating patterns of the individual layers are separated during weaving

In some embodiments, cross-link fibers can be woven into a third Z-axes (e.g. by 3D weaving techniques) by using insertion cramming techniques to force an insertion yarn to draw into the Z-axis due to the torque force exerted on the fabric while the fabric is being woven. Typical weaving involves weaving while a forward motion continually rolls up the fabric resulting in even tension. However, as in this case, if the forward motion of a loom is stopped while weaving continues (e.g. “insertion cramming”) the residual potential torque load within the fabric at beat up tends to force the inserted yarn into the third axis (Z-axis) when forward motion resumes. Cramming can generally be defined as a forward motion pause, but where weaving/yarn insertion continues.

Such cramming techniques can also be used to secure alternative yarns within a multi-layer fabric to support the addition of other mechanical properties.

In some cases, these techniques may provide an improvement over traditional weaves due to the distribution of fibers on two or more planes. In particular, this may provide an alternative for knit products for improved coating and lamination (also called a “mock-knit”). Knitted products tend to stretch and move resulting in at least two issues, namely residual internal stresses, and distortion and uneven or ineffective coatings and lamination. In some embodiments, the layers of fabric are cross-linked together to provide the fabric with at least one physical properties of a knit fabric (e.g. hand, etc.) without some of the other drawbacks of a knitted product.

Furthermore, the tie in yarns when woven in a specified pattern, whether crammed or not, provide shear resistance without preventing the multilayer from bending as two separate individual woven fabrics would (not unlike a loose stitch).

Woven fabrics, as compared to knits, are structurally stable (e.g. they tend not to stretch). Accordingly, a multi-layer weave that does not stretch in multiple dimensions may be easier to coat, laminate, and/or process through a converting operation (unlike a knit fabric). Also, when knit fabrics are coated, laminated, or converted into a fixed state, there usually exist residual tensions (typically in shear against whatever the knit substrate is laminated, coated, or stitched to).

These residual tensions may reduce the reliability or rigidity (or both) of the end product that uses a knit, particular since because these tensions tend to want to fight to “un-stretch”. However, this is usually not an issue with woven fabrics. Accordingly, some of the multi-layer fabrics as described herein may maintain the “hand” (e.g. ductility/flexibility) and thickness of a knit but without impose some of the same process and durability issues.

As introduced above, the 3-1 Rev Twill layer generally provides a flat surface that is suitable for lamination, coating and garment manufacturing (or other purposes), while the plain weave layer generally provides structure and additional yarn layering for improved thermal performance. In this manner, a multi-layer fabric can generally be woven that has a desired level of thermal performance as well as desired mechanical properties.

Various weaving styles may be applied to a multi-layer platform (e.g. twill, satin, plain woven, etc.) depending on the desired properties of the finished fabric. For example, a multi-layer fabric could include a fancy weave pattern layer on one side of the fabric coupled to a satin layer on the other side of the fabric.

According to one aspect, one differentiating factor between the embodiments generally described herein and traditional multilayer designs is the pattern of the cross links in the weft direction. Generally, a cross link may be described as an interruption in the repeat of the fabric pattern, or as a separate integrated cross link pattern integrated with the main body pattern in the warp or weft directions (or both). For example, a cross link may be provided as an interruption between the repeats of a multi-layer fabric, with a cross link provided between the top layer (e.g. an upper layer) and bottom layer (e.g. a lower layer) to secure the layers together.

In some embodiments, it may be desirable to provide at least one layers that are “fluffed” (e.g. with lots of air gaps or spaces in the fabric layers), so as to provide good thermal properties, since air tends to be an effective insulator.

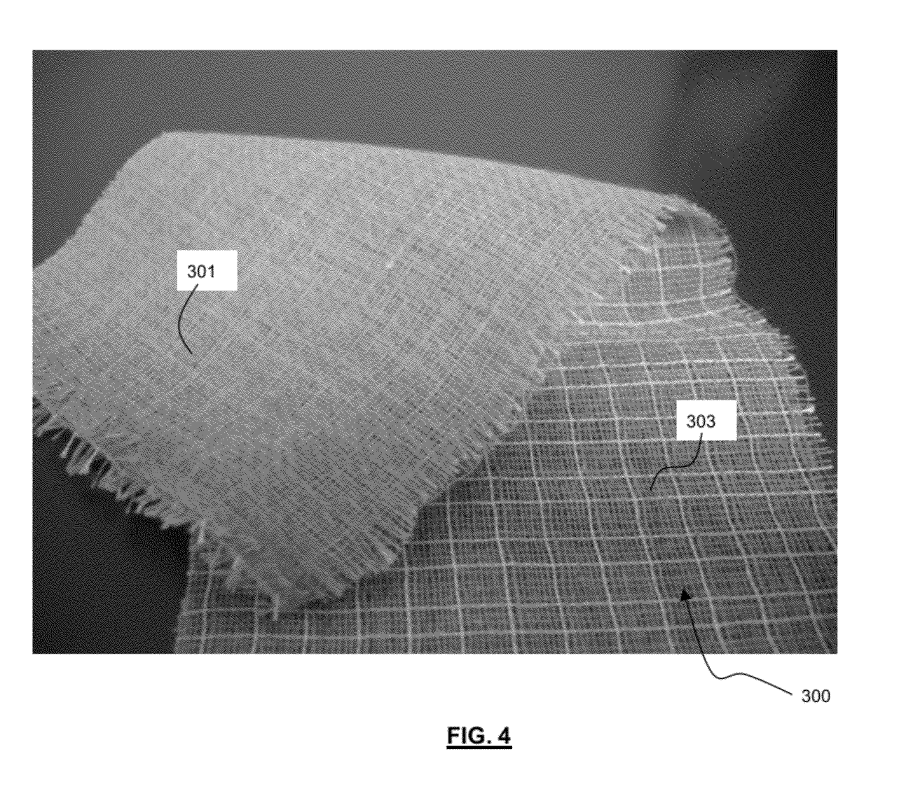

Some embodiments herein are directed to a variation of multi-layer fabric that tends to provide for greater strength as compared to conventional multi-layer fabrics. Typical multi-layer fabrics include two separate layers that are woven in parallel (as shown for example in FIGS. 4 and 5). However, one inherent problem with such multi-layer fabrics is that the substrate is susceptible to shear damage during use resulting in the layers falling apart or disconnecting from each other.

Accordingly, and as generally described herein, by providing one or more stronger cross-link yarns (e.g. aramid, carbon, FR treated rayon, ceramic yarns or other cross-link yarns) to further secure multiple layers together, the overall robustness of the multi-layer fabrics may be increased.

One or more of the fabrics as generally described herein may be used for various thermal protection markets, and may provide for flame resistance, thermal transmission protection, protection against arc flash and molten metal splash, and so on. In some cases, the multi-layer platform should be lamination/coating friendly, exhibit better thermal efficiencies than existing single layer woven products, and be shear/abrasion resistant.

In some embodiments, the flame resistant fibres could include polybenzimidazole (PBI) fibers. In some embodiments, flame resistance PBI fibers may be used in combination with aramid fibers, and in some cases with aramid cross-link fibers. In some other embodiments, glass may be another suitable yarn. In other embodiments, other suitable yarns may be used, such as aramids, chemically treated FR polyester, rayon, ceramic yarns, core spun glass fibers, carbon, preox, Nomex, and various blended spun yards.

At least some of the embodiments as described herein may provide one or more advantages or benefits as compared to traditional thermal protection fabrics (e.g. single layer knit or woven fabrics). For example, some embodiments may provide for higher thermal efficiency (e.g. FFF Value=(cal/cm̂2)/(oz/yd̂2)−a thermal performance to fabric weight ratio), which may increase the insulative properties of the multi-layer fabric over a typical single layer fabric.

Some embodiments may also provide for improved shear resistance and/or abrasion resistance. Some embodiments may allow for a fabric to be provided that uses various yarn combinations at various warp and weft densities to obtain desired mechanical and/or thermal properties.

In some embodiments, fabrics may be provided having multiple surface characteristics depending on the particular weave pattern(s) chosen for each of the fabric layers (e.g. twill, satin, fancy weave, plain weave, etc.).

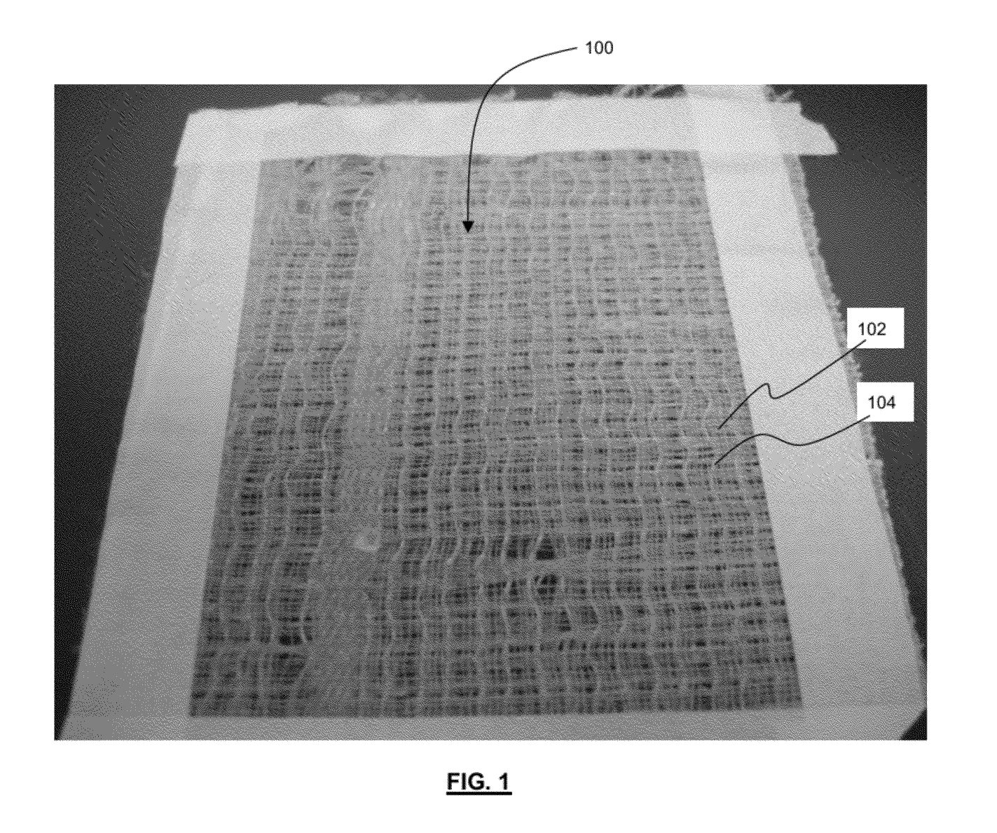

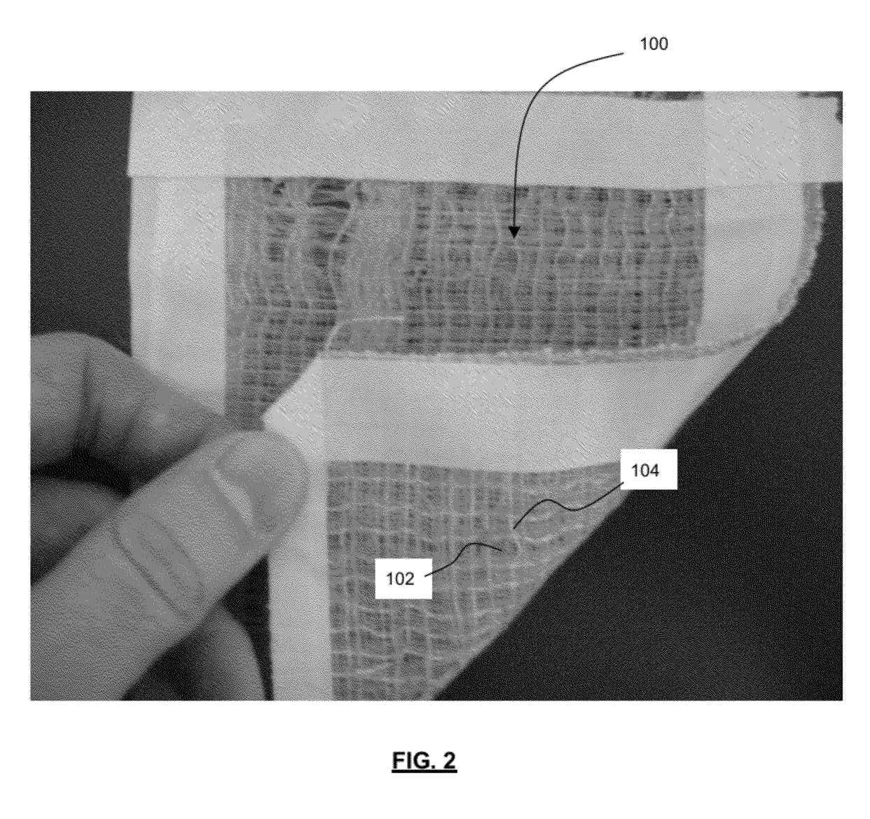

Turning now to FIGS. 1 and 2, illustrated therein is a fabric 100 designed for thermal protection according to one embodiment. As shown, the fabric 100 has a generally open and loose appearance, however, yarns are layered in “two” planes and are inter connected with at least two types of yarns: a smaller blended PBI/Aramid for thermal protection (e.g. first cross link yarns that help secure the layers together but which generally do not improve the structural properties of the fabric) and a larger spun aramid (e.g. second cross link yarns) that provide structural integrity and multi-layer shear resistance to the fabric.

In this embodiment, the thinner flame resistant fibers are indicated generally as 102, and the larger spun aramid fibers are indicated generally as 104.

The two layers in the fabric 100 are cross linked with two types of yarn. The “highly” flame resistant but low tensile strength PBI/Aramid blended yarn and a flame resistant but high tensile spun Aramid yarn. The PBI/Aramid yarn provides the bulk of the thermal protection within the two planes of the woven substrate. The spun aramid yarn is added as an additional cross link (with a particular pattern) in both the warp and weft directions, and may add several mechanical properties to the multilayer fabric 100, such as increasing the overall fabric break strength, improving trapezoidal tear, improving abrasion resistance, and improving shear resistance between the two layers of woven PBI/Aramid layers.

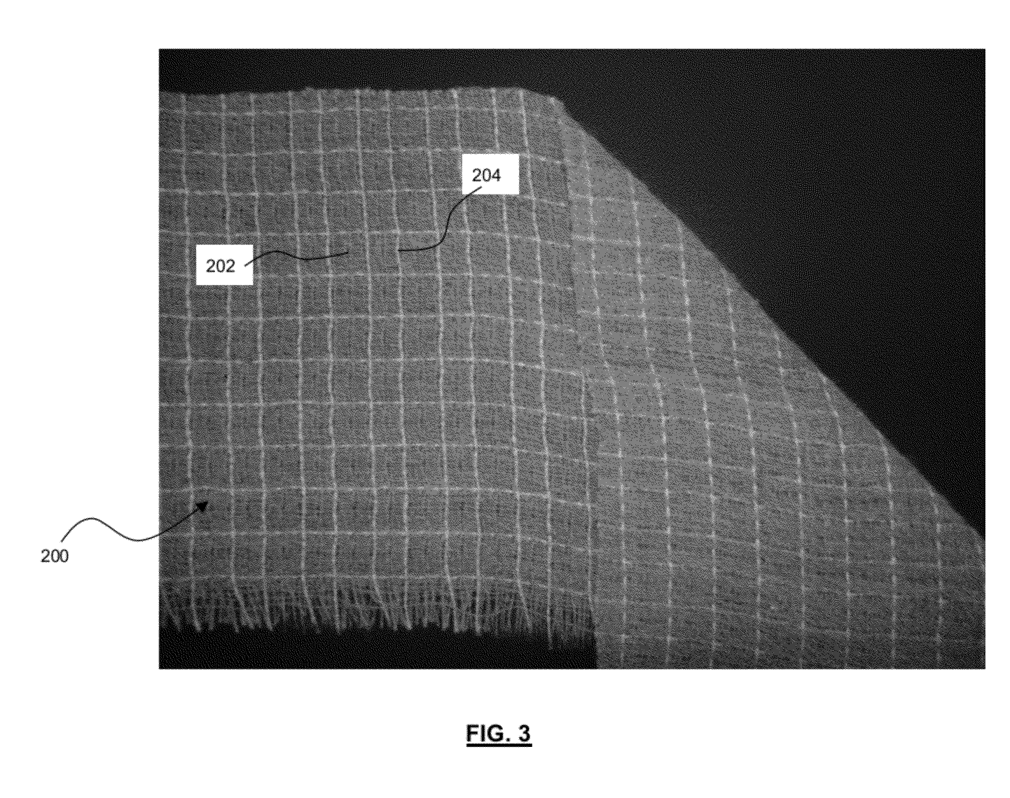

FIG. 3 is an image of another fabric 200 designed for thermal protection according to another embodiment. Generally the fabric 200 is similar to the fabric 100 (e.g. has the same or a substantially similar pattern as fabric 100) with flame resistant fibers 202 and structural fibers 204. In this embodiment, however, the structural fibers are multi-filament non-spun aramid fibers. As with the fabric 100, the fabric 200 includes various cross link fibers for securing the different layers together, including cross links made from flame resistant fibers 202 (for securing the layers of the fabric 200 together) and cross links made with structural fibers 204 (which are designed to improve the mechanical properties of the fabric 200)

### Experimental Data

According to one experiment, a comparative analysis was performed on a single layer of fabric generally as shown in FIG. 3 (e.g. a PBI/Aramid Blended yarn with a multifilament non spun aramid structural fibers) as compared to a typical knit control sample. Results of this comparison are provided below in Table 1.

TABLE 1

| | FIG. 3 | Control Sample |
|---|---|---|
| | Fabric | (Typical Knit) |
| Sample Weight (oz/yd\hat{ }2) | 2.96 | 4.75 |
| Thermal Protection Performance (TPP) Time | 3.80 | 4.03 |
| (sec) | | |
| TPP Value (cal/cm\hat{ }2) | 7.57 | 8.03 |
| FFF Value* ((cal/cm\hat{ }2)/(oz/yd\hat{ }2)) | 2.57 | 1.70 |
| After Flame (sec.) - Warp | 0.00 | 0.00 |
| After Glow (sec) - Warp | 4.45 | 7.29 |
| Char Length (in) - Warp | 0.30 | 0.30 |
| After Flame (sec.) - Weft | 0.00 | 0.00 |
| After Glow (sec) - Weft | 3.44 | 14.12 |
| Char Length (in) - Weft | 0.70 | 0.10 |

*FFF = Key material performance value (higher the better), ratio of TPP to Weight

As shown in Table 1, the fabric of FIG. 3 generally provided improved properties in several areas, including decreased weight (with a resulting higher FFF value or thermal efficiency ratio) and improved flame resistance characteristics. The higher thermal efficiency ratio indicated that there is a performance increase in the multilayer fabric as compared to the control sample.

Turning now to FIGS. 4 and 5, illustrated therein is a conventional multi-layer fabric 300 where two layers of fabric are woven in parallel without cross links. In particular, in this embodiment the layers of the fabric 300 can be seen, including a separate first layer 301 and second layer 303. The layers 301, 303 are not secured together using one or more cross link yarns (see in particular FIG. 5 where the layers 301, 303 are shown being pulled apart). As such, this type of fabric 300 would tend to fall apart (e.g. with the layers separating) when used in a garment or other type of clothing, which is generally undesirable.

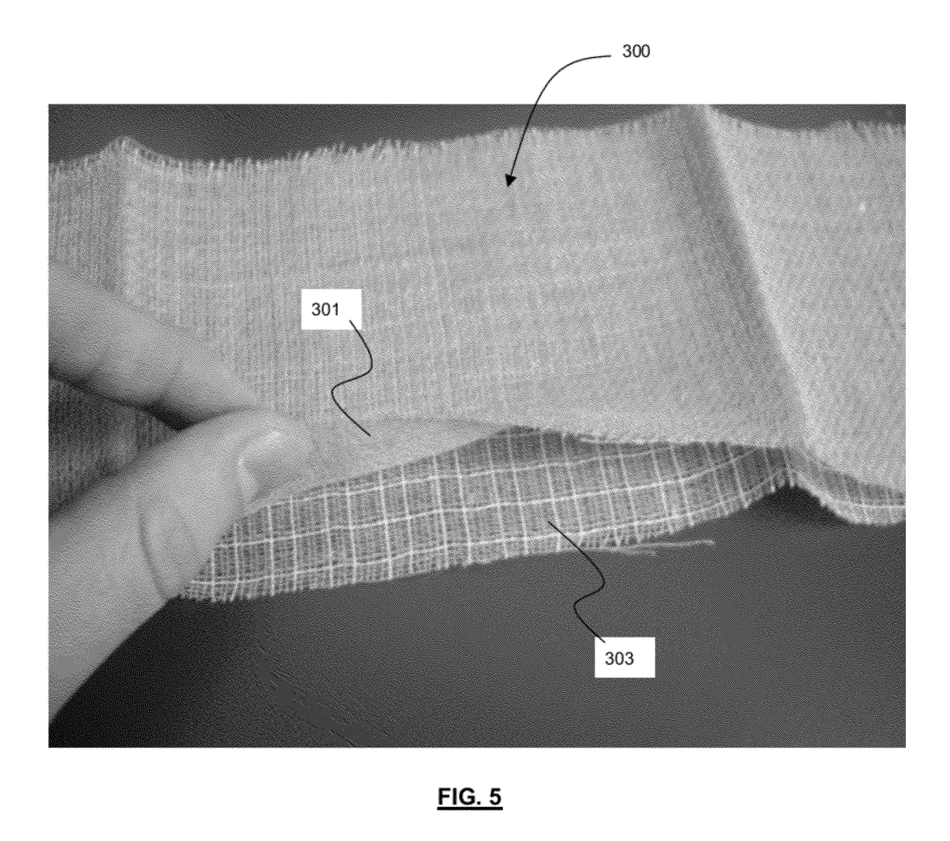

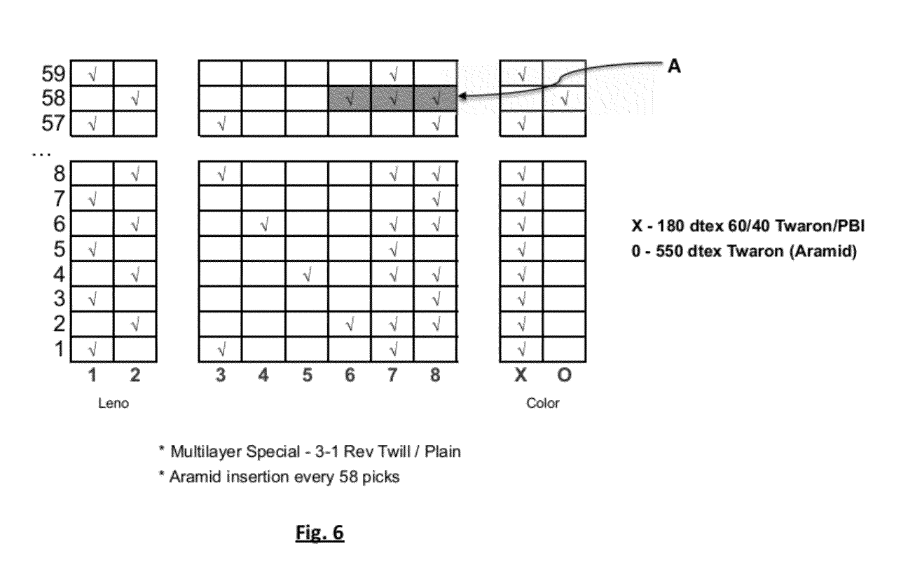

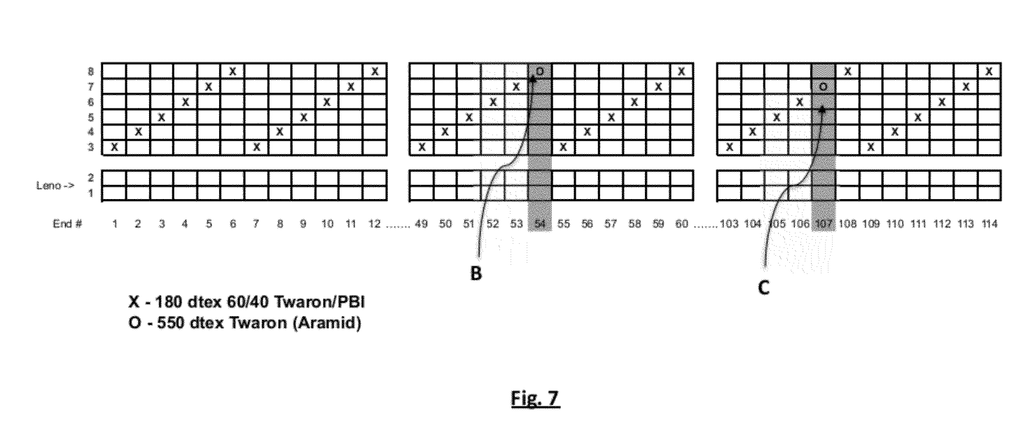

Turning now to FIGS. 6 and 7, one particular example multi-layer fabric according to the teachings herein is shown schematically therein. In this embodiment, a 3-1 Rev Twill/Plain Weave multi-layer fabric was woven using 180 dtex 60/40 Twaron/PBI as the main flame resistant fibers and 550 dtex Twaron (multifilament non-spun aramid) as an additional cross-link fibers adapted to improve mechanical properties.

As shown, in this embodiment a 180 dtex 60/40 Twaron/PBI cross link is provided at approximately every 9 picks, with a larger 550dtex Twaron cross-link fiber inserted every 58 picks (e.g. with an aramid draw approximately every 54 ends) replacing the 180 dtex 60/40, as indicated generally by the columns and row highlighted by reference characters A, B and C.

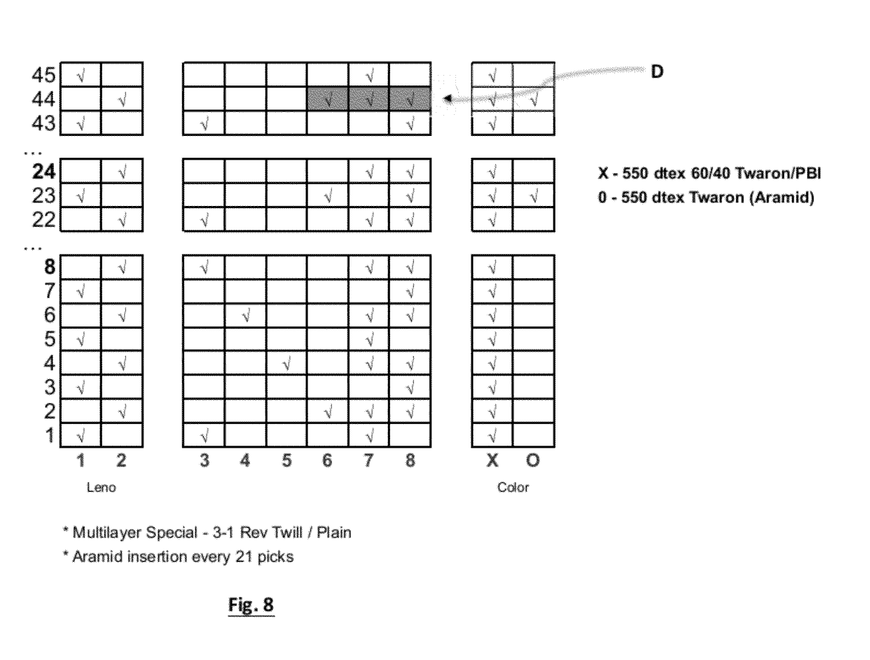

Another particular example multi-layer fabric is shown in FIGS. 8 and 9, which also provides a 3-1 Rev Twill/Plain Weave multi-layer fabric. However, this fabric is woven using 550 dtex 60/40 Twaron/PBI as the main flame resistant fibers and 550 dtex Twaron (multifilament non-spun aramid) as the structural fibers. In this embodiment first cross link fibers may be provided using the 550 dtex 60/40 Twaron/PBI (e.g. approximately every 9 picks) while an aramid cross-link fiber may be inserted every 21 picks (e.g. with an aramid draw approximately every 18 ends), as indicated generally by the reference characters D, E and F.

In other embodiments, various other spacing for the crosslink fibers or yarns may be provided in one or more patterns within a standard weaving pattern (e.g. twill/satin/plain) or as part of the existing typical weave pattern itself according to the desired properties of the completed multi-layer fabric. For example, in some embodiments a cross-link fiber (e.g. an aramid structural fiber such as Twaron) may be inserted at a frequency greater than every 60 picks, greater than every 30 picks, less than every 30 picks, and less than every 20 picks.

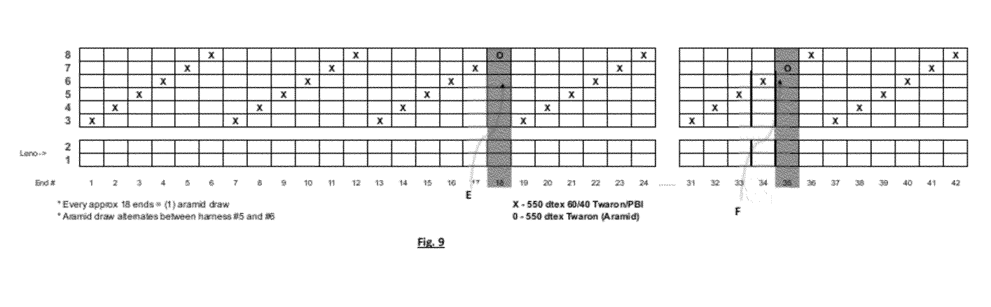

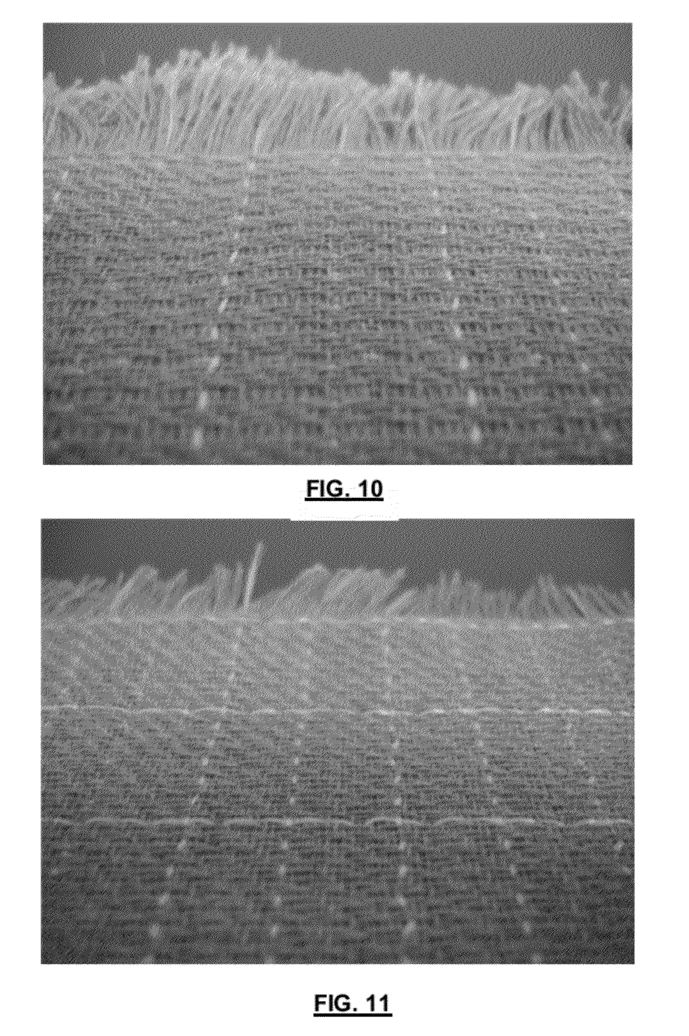

In some embodiments, one or more multi-layer fabrics may be blended. For example, FIG. 10 is an image of a twill/plain weave multi-layer fabric (e.g. a non-blended fabric) while FIG. 11 is an image of a blended twill/plain weave multi-layer fabric.

Blending cross-link fibers tend to enable the patterns within both planes of a multilayer fabric weave to be blended together (unlike a traditional multi-layer) thus creating a more uniform surface continuity. In contrast, a standard (e.g. non-blended) multi-layer fabric may have gaps where either the cross-links are exposed or the alternating patterns of the individual layers are separated during weaving. As such, a blended multi-layer fabric may have improved properties for some applications.

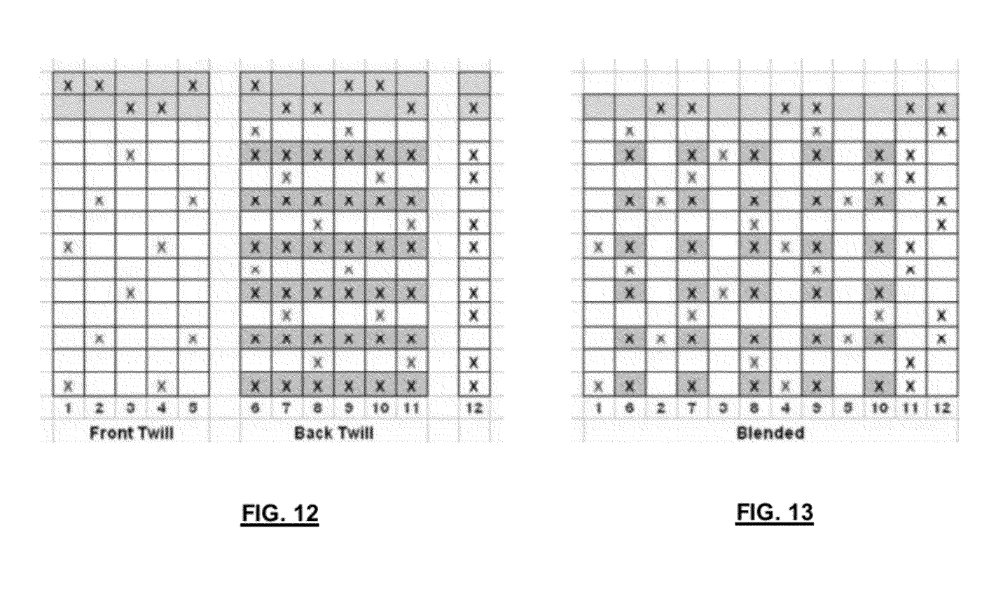

In various embodiments, different blending schemes may be used with such a multi-layer fabric. For example, FIG. 12 is a schematic of a pattern of the non-blended multi-layer fabric of FIG. 10, while FIG. 13 shows a schematic of a pattern for the blended twill/plain weave multi-layer fabric of FIG. 11.

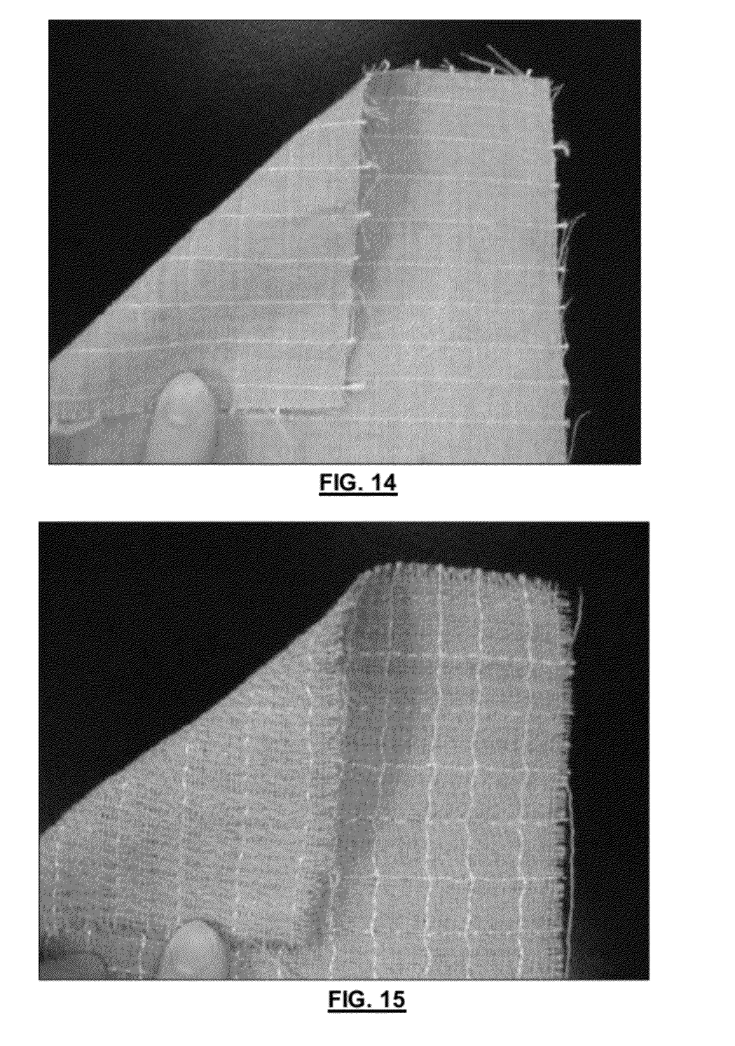

In other embodiments, one or more other yarn combinations may be used for various performance effects. For example, FIG. 14 shows an image of a sample fabric Sample AA comprising (32/1 cc PBI/Twaron 3-1 Twill/Plain), 197 gsm. Similarly, FIG. 15 shows an image of a sample fabric Sample BB comprising (20/2 cc PBI/Kevlar 3-1 Twill/Plain), 197 gsm, which uses 40/60 PBI/Kevlar as the main flame resistant fibers and 500 denier Twaron as the structural fibers. Performance data for Samples AA and BB is provided in Table 2 below.

TABLE 2

| | Sample AA | Sample BB |
|---|---|---|
| Sample Weight (oz/yd\hat{ }2) | 5.84 | 5.88 |
| Thickness (mm) | 0.52 | 0.71 |
| NFPA Trapezoid Tear Test | 32.45/42.55 | 72.9 × 81.3 |
| (lbf) - Warp × Weft | | |
| TPP Value (cal/cm\hat{ }2) | 9.83 | 9.42 |
| FFF Value* ((cal/cm\hat{ }2)/(oz/yd\hat{ }2)) | 1.67 | 1.6 |
| After Flame (sec.) - Warp × Weft | n/a | 0 × 0 |
| After Glow (sec) - Warp × Weft | n/a | 5.5 × 9.7 |
| Char Length (in) - Warp × Weft | n/a | 0.1 × 0.1 |
| Stoll Flex Test (cycles) - | 2039 × 1822 | n/a |
| Warp × Weft | | |
| Tabor Abrasion (cycles) | 189 | 97 |
| Warp/Weft Yarn (Body) | 40/60 PBI/MD | 40/60 PBI/Kevlar |
| | Twaron (32/1) | (20/2) |
| Warp/Weft Yarn (Structure) | 500 denier | 500 denier Twaron |
| | Twaron | |

As used herein, the terms “fiber” generally refer to an elongated body for which the length dimension is significantly greater than the transverse or width dimension. In some embodiments, at least one of the fibers may include polyester fibers, aramid fibers, glass fibers, basalt fibers, carbon fibers, spun/blended fibers, chemically treated fibers, or some combination thereof.

In some embodiments, at least some of the fibers are flame resistant fibers, such as Polybenzimidazole (PBI), glass fibers, aramid fibers, and so on or has some innate thermal protection capability (i.e. ceramic or carbon fibers).

Multilayer fabrics as described herein tend to be more insulative than single layers due to the additional layering or spacing proved by the pattern. They may also provide on or more other benefits, including higher strength, improved cut resistance, increased shear resistance, increased abrasion resistance, better comfort, more color options, and so on.

An additional benefit is that the multilayer platform may allow for better composite weaves (e.g. the integration of other yarns to provide other physical characteristics).

In some embodiments as described herein, cross linked yarns can be hidden or strategically placed within the multilayer pattern, and thus various types of cross link fibers can be used (including cross link fibers which might tend to melt when exposed to elevated temperatures). This would be more difficult to do within a single fabric layer since all the yarns are present on both the front and the back faces of the fabric.

Other fibers may include extended chain polyethylene fibers, and/or poly(p-phenylene-2,6-benzobisoxazole) (PBO) fibers. Other examples could include aramid and copolymer aramid fibers, for example as produced commercially by DuPont (Kevlar®), Teijin (Twaron®), Kolon (Heracron®), and Hyosung Aramid, modified aramids (e.g. Rusar®, Autex®), ultra high molecular weight polyethylene (UHMWPE) produced commercially by Honeywell, DSM, and Mitsui under the trade names Spectra®, Dyneema®, and Tekmilon®, respectively (as well as Pegasus® yarn), poly(p-phenylene-2,6-benzobisoxazole) (PBO) (produced by Toyobo under the commercial name Zylon®), and/or polyester-polyarylate yarns (e.g. Liquid crystal polymers produced by Kuraray under the trade name Vectran®). In some embodiments, industrial fibers such as Nylon, polyester, polyolefin based yarns (including polyethylene and polypropylene), could also be used. In some embodiments, the fibers may include ceramic fibers (e.g. 3M Nextel fibers), Carbon-X, carbon fibers, and various blends.

In some embodiments, the fibers may be made from aliphatic (non-aromatic) low-density polyolefins, such as high-molecular weight polyethylene (UHMWPE), polypropylene, and synthetic fibers such as PET or Nylon/Amides. UHMWPE is not typically used for thermal protection, however, a composite multilayer that includes UHMWPE fibers in addition to a typical thermally protective fiber (such as a PBI blend or spun aramid) may provide slash/cut resistance in addition to thermal protection (e.g. a hybridized product).

Generally, one or more multi-layer fabrics as described herein may be used for various types of thermal protection, including for use in garments (e.g. shirts, pants, etc.), structures, composites/hybrids, thermal shields, and so on. In some embodiments, the fabrics as described herein could be used to protect equipment or instrumentation, and could serve as a heat shield of firewall.

For example, some fibers as described herein may be useful in automotive applications (particularly racing applications) to protect a driver and/or passengers from heat radiating from an engine or from other components of the car. In such an example, the woven multi-layer fabric may be a component in a composite structure.

While the above description provides examples of one or more thermal protective fabrics, it will be appreciated that other fabrics and methods of forming the same may be within the scope of the present description as interpreted by one of skill in the art.

1. A multi-layer thermal protective fabric comprising,
a first layer having at least some yarns having flame resistant properties;
a second layer adjacent the first layer; and
at least one cross link yarn securing the first layer to the second layer.

2. The fabric of claim 1, wherein the at least one cross link yarn includes a flame resistant yarn adapted to secure the first and second layers together.

3. The fabric of claim 1, wherein the at least one cross link yarn includes a structural yarn.

4. The fabric of claim 3, wherein the structural yarn is selected to improve the mechanical properties of the fabric.

5. The fabric of claim 1, wherein the second layer includes at least some thermal protective yarn.

6. The fabric of claim 1, wherein the at least one cross link yarn includes an structural aramid yarn interwoven with the first and second layers.

7. The fabric of claim 6, wherein the structural aramid yarn is a spun yarn.

8. The fabric of claim 6, wherein the structural aramid yarn is a multifilament non-spun yarn.

9. The fabric of claim 1, wherein the yarns having flame resistant properties include polybenzimidazole yarns.

10. The fabric of claim 1, wherein at least one of the first layer and second layer is a plain woven layer.

11. The fabric of claim 1, wherein at least one of the first layer and second layer is a twill layer.

12. The fabric of claim 1, wherein at least one of the first layer and second layer is a satin layer.

13. The fabric of claim 1, wherein at least one of the first layer and second layer is a fancy woven layer.

14. The fabric of claim 1, wherein at least some of the cross-links fibres are blended so as to provide a more uniform surface continuity.

15. The fabric of claim 1, wherein the layers of fabric are cross-linked together to provide the fabric with at least one physical properties of a knit fabric.

16. The fabric of claim 1, comprising at least one integrated cross link pattern integrated with the main body pattern in at least one of the warp or weft directions.

17. A method of forming a multi-layer thermal protective fabric, comprising weaving a crosslink fabric with a first and second layer, wherein at least one of the first and second layer has yarns comprising flame resistant properties.

18. The method of claim 17, wherein the at least one cross link yarn includes a flame resistant yarn adapted to secure the first and second layers together.

19. The method of claim 17, wherein the at least one cross link yarn includes a structural yarn.

20. The method of claim 19, wherein the structural yarn is selected to improve the mechanical properties of the fabric.

21. The method of claim 17, wherein the second layer includes at least some thermal protective yarn.

22. The method of claim 17, wherein the at least one cross link yarn includes a structural aramid yarn interwoven with the first and second layers.

23. The method of claim 22, wherein the structural aramid yarn is a spun yarn.

24. The method of claim 22, wherein the structural aramid yarn is a multifilament non-spun yarn.

25. The method of claim 17, wherein at least one of the first layer and second layer is a plain woven layer.

26. The method of claim 17, wherein at least one of the first layer and second layer is a twill layer.

27. The method of claim 17, wherein at least one of the first layer and second layer is a satin layer.

28. The method of claim 17, wherein at least one of the first layer and second layer is a fancy woven layer.

29. The method of claim 17, wherein the second layer includes at least some thermal protective yarn.

30. The method of claim 17, wherein the at least one cross link yarn includes an aramid yarn.

31. The method of claim 17, wherein the yarns having flame resistant properties include polybenzimidazole yarns.
